(19) United States
(12) Patent Application Publication
(10) Pub. No.: US 2026/0185950 A1
(43) Pub. Date: Jul. 2, 2026

(54) IMAGING SUPPORT APPARATUS, IMAGING SUPPORT METHOD, IMAGING SUPPORT PROGRAM, AND RADIOGRAPHIC IMAGING APPARATUS

(71) Applicant: FUJIFILM Corporation, Tokyo (JP)

(72) Inventors: Hisatsugu HORIUCHI, Tokyo (JP); Atsushi ONODA, Tokyo (JP); Tsukasa ICHIJO, Tokyo (JP); Takeyasu KOBAYASHI, Tokyo (JP); Moeka KITAMURA, Tokyo (JP)

(73) Assignee: FUJIFILM Corporation, Tokyo (JP)

(21) Appl. No.: 19/415,870

(22) Filed: Dec. 11, 2025

(30) Foreign Application Priority Data
Dec. 27, 2024 (JP) 2024-232513

(51) Int. Cl. G01N 23/04; G01B 11/02

(52) U.S. Cl. CPC G01N 23/04; G01B 11/022; G01N 2223/301; G01N 2223/3037; G01N 2223/306; G01N 2223/308; G01N 2223/309; G01N 2223/408

(57) ABSTRACT

In a case of supporting imaging of a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, a processor determines completion of each of a plurality of operation processes for alignment of the radiographic imaging apparatus, and displays an indicator for the alignment corresponding to the completed operation process on the display.

### CROSS-REFERENCE TO RELATED APPLICATION

The present application claims priority from Japanese Patent Application No. 2024-232513, filed on Dec. 27, 2024, the entire disclosure of which is incorporated herein by reference.

### BACKGROUND

### Technical Field

The present disclosure relates to an imaging support apparatus, an imaging support method, an imaging support program, and a radiographic imaging apparatus.

### Related Art

A radiation image of a patient is captured using a radiation detector at a ward-round destination using a mobile radiographic imaging apparatus (ward-round cart). In a case where the radiographic imaging is performed at the ward-round destination in this way, it is required to align a radiation source and the radiation detector. Specifically, it is required to adjust a distance, a relative position, a relative angle between the radiation source and the radiation detector such that a source to image receptor distance (SID), which is a spacing between the radiation source and the radiation detector, matches a target distance, a center of radiation emitted from the source matches an imaging center of a subject, and an optical axis of the radiation intersects the radiation detector perpendicularly. Therefore, a method of displaying an indicator required for alignment, such as the SID, an angle of the radiation source, and an angle of the radiation detector, on a display provided in a radiographic imaging apparatus to support the alignment has been proposed (see, for example, JP2023-116868A).

In addition, a method of displaying an indicator representing a center of a subject and an indicator representing a center of an irradiation field of radiation on a display, and displaying a relative angle between a radiation source and a radiation detector on the display in a case where positions of the two indicators match has also been proposed (see JP2016-196791A).

In a case where the subject is imaged using the mobile radiographic imaging apparatus, the imaging is performed after a plurality of operations such as installation of the radiographic imaging apparatus, unfolding of an arm, setting of the radiation detector, adjustment of imaging positions, adjustment of the SID, adjustment of the relative angle between the radiation source and the radiation detector, and confirmation of the imaging conditions are performed. In a case where a large number of indicators such as the SID, the angle of the radiation source, and the angle of the radiation detector are displayed on the display while the plurality of operations are being performed, the display content becomes complicated, and it is difficult to check the indicator required for the current operation process. In the method disclosed in JP2016-196791A, in a case where the indicator representing the center of the subject matches the indicator representing the center of the radiation irradiation field, the relative angle is displayed on the display in addition to the indicators displayed during the preceding operation processes. Therefore, the indicator required for the operation process is displayed on the display, but the indicators required for the other operation processes are also displayed, and it is difficult to check the required indicator.

### SUMMARY OF THE INVENTION

The present disclosure has been made in view of the above-described circumstances, and an object thereof is to make it easy to check information required in each operation process in a case where imaging is performed using the mobile radiographic imaging apparatus.

The present disclosure relates to an imaging support apparatus for a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, the imaging support apparatus comprising: a display; and a processor, in which the processor is configured to: determine completion of each of a plurality of operation processes for alignment of the radiographic imaging apparatus; and display an indicator for the alignment corresponding to the completed operation process on the display.

In the imaging support apparatus according to the present disclosure, the processor may be configured to display the indicator for the alignment corresponding to the completed operation process instead of an indicator displayed on the display during the completed operation process.

In the imaging support apparatus according to the present disclosure, the processor may be configured to determine the completion of the operation process in accordance with at least one of whether an angle of the arm has reached a predetermined angle, whether a distance from the radiation source to a surface of a patient table on which the subject is placed or to a detection surface of a radiation detector installed behind the subject has reached a predetermined distance, whether a relative angle between the radiation source and the radiation detector has reached a predetermined angle, whether a target position of the subject and an irradiation center of the radiation have fallen within a predetermined range, or whether an operation by an operator has been received.

In the imaging support apparatus according to the present disclosure, the indicator may include at least one of a distance from the radiation source to a surface of a patient table on which the subject is placed or to a detection surface of a radiation detector installed behind the subject, a relative angle between the radiation source and the radiation detector, a target position of the subject, an irradiation center of the radiation, imaging conditions, or a body thickness of the subject.

In the imaging support apparatus according to the present disclosure, the processor may be configured to change the indicator displayed on the display in accordance with an imaging menu for imaging the subject.

In the imaging support apparatus according to the present disclosure, the processor may be configured to change the indicator in accordance with precision of the alignment in an operation process to be performed next to the completed operation process.

In the imaging support apparatus according to the present disclosure, the processor may be configured to, in a case where the alignment is completed in at least one of the plurality of operation processes, instruct the radiographic imaging apparatus to perform an operation indicating that the alignment is completed.

In the imaging support apparatus according to the present disclosure, the processor may be configured to determine that the alignment is completed in at least one of the plurality of operation processes in accordance with at least one of whether a distance from the radiation source to a surface of a patient table on which the subject is placed or to a detection surface of a radiation detector installed behind the subject has fallen within a predetermined distance range, whether a relative angle between the radiation source and the radiation detector has fallen within a predetermined angle range, or whether a distance between an irradiation center of the radiation and a target position of the subject has fallen within a predetermined distance range.

In the imaging support apparatus according to the present disclosure, the processor may be configured to instruct the radiographic imaging apparatus to perform an operation of irradiating the subject with a light irradiation field as the operation indicating that the alignment is completed.

In the imaging support apparatus according to the present disclosure, the processor may be configured to, in a case where the alignment departs from a completed state, instruct the radiographic imaging apparatus to perform an operation of turning off the light irradiation field.

In the imaging support apparatus according to the present disclosure, the display may be mounted on a radiation source unit including the radiation source.

The present disclosure relates to an imaging support method for a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, the imaging support method being executed by a computer, the imaging support method comprising: determining completion of each of a plurality of operation processes for alignment of the radiographic imaging apparatus; and displaying an indicator for the alignment corresponding to the completed operation process on a display.

The present disclosure relates to an imaging support program for a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, the imaging support program causing a computer to execute: a procedure of determining completion of each of a plurality of operation processes for alignment of the radiographic imaging apparatus; and a procedure of displaying an indicator for the alignment corresponding to the completed operation process on a display.

It should be noted that the disclosed technology may be applied to a program product.

The present disclosure relates to a radiographic imaging apparatus comprising: a radiation source that emits radiation; a body that is movable; an arm that is foldable and that connects the body to the radiation source; a sensor that acquires distance information representing an imaging distance in a direction from the radiation source toward a subject; an optical camera that is mounted on the radiation source and that captures an optical image in the direction from the radiation source toward the subject; and the imaging support apparatus according to the present disclosure.

According to the present disclosure, it is possible to easily check the information required in each operation process in a case where the imaging is performed using the mobile radiographic imaging apparatus.

### BRIEF DESCRIPTION OF THE DRAWINGS

FIG. 1 is an external perspective view of a radiographic imaging apparatus to which an imaging support apparatus according to the present embodiment is applied.

FIG. 2 is a diagram illustrating a state where the radiographic imaging apparatus according to the present embodiment is used.

FIG. 3 is a diagram illustrating a detailed configuration of a radiation source unit.

FIG. 4 is a diagram illustrating a hardware configuration of the imaging support apparatus according to the present embodiment.

FIG. 5 is a functional block diagram of the imaging support apparatus according to the present embodiment.

FIG. 6 is a diagram illustrating plane detection.

FIG. 7 is a diagram illustrating a display screen of a display after completion of a first operation process.

FIG. 8 is a diagram illustrating a display screen of the display after completion of a second operation process.

FIG. 9 is a diagram illustrating a display screen of the display immediately before completion of a third operation process.

FIG. 10 is a diagram illustrating a display screen of the display after completion of a fourth operation process.

FIG. 11 is a flowchart illustrating processing performed in the present embodiment.

FIG. 12 is a flowchart illustrating the processing performed in the present embodiment.

FIG. 13 is a diagram illustrating another example of the display screen of the display after the completion of the second operation process.

### DETAILED DESCRIPTION

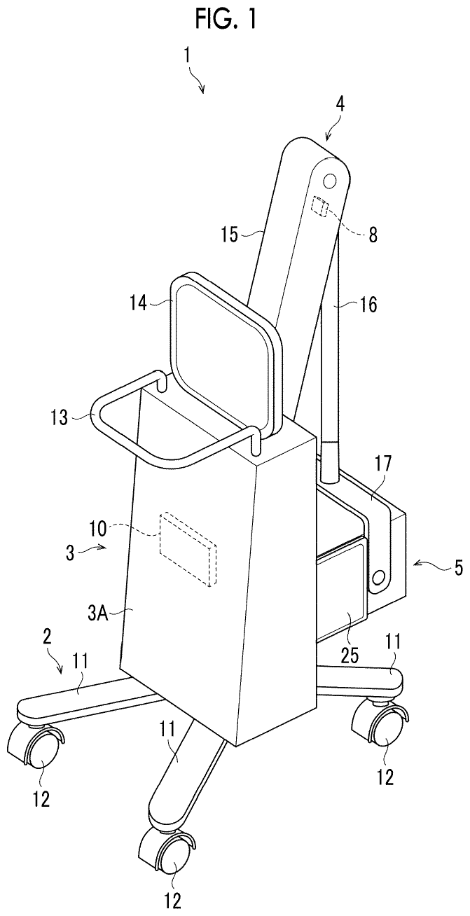

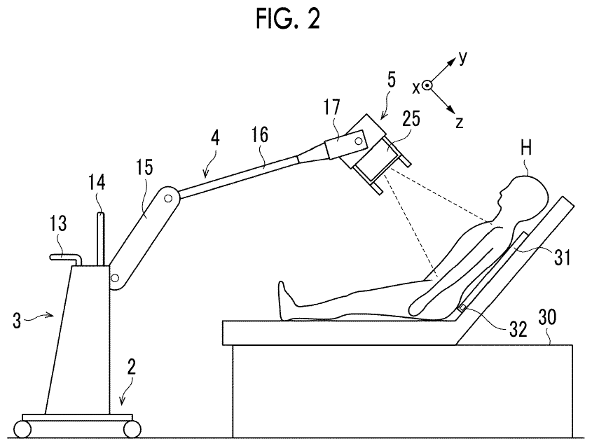

Hereinafter, an embodiment of the present disclosure will be described with reference to the accompanying drawings. FIG. 1 is an external perspective view of a radiographic imaging apparatus to which an imaging support apparatus according to the present embodiment is applied, and FIG. 2 is a diagram illustrating a state where the radiographic imaging apparatus according to the present embodiment is used. A radiographic imaging apparatus 1 to which the imaging support apparatus according to the present embodiment is applied is a ward-round cart type radiographic imaging apparatus, and includes a leg part 2 that is movable on an apparatus placement surface, a body 3 that is supported on the leg part 2, an arm 4 that is connected to the body 3, and a radiation source unit 5 that is mounted on a distal end portion of the arm 4.

The leg part 2 includes four legs 11 and wheel parts 12 mounted on lower surfaces of distal end portions of the legs 11. A stopper (not illustrated) is provided in the wheel part 12 such that the wheels do not rotate unintentionally.

The body 3 accommodates a computer 10, a battery, and the like for controlling the radiographic imaging apparatus 1 in a housing 3A. The computer 10 includes the imaging support apparatus according to the present embodiment. A handle 13 for pushing or pulling the radiographic imaging apparatus is mounted on an upper end of the housing 3A. An operation panel 14 is mounted on an upper portion of the housing 3A.

As the operation panel 14, a touch panel type is adopted in which a display is integrated, and the operation panel 14 receives an instruction of an operator, such as setting of imaging conditions and imaging start, and inputs the instruction to the radiographic imaging apparatus 1. As an imaging menu, chest imaging, extremity imaging, upper-body imaging, and the like can be set.

The arm 4 consists of a first member 15 and a second member 16 that are foldable. The first member 15 is connected to the body 3 so as to be rotatable in an up-down direction. The first member 15 and the second member 16 are connected so as to be rotatable relative to each other. A potentiometer 8 for detecting an angle between the first member 15 and the second member 16 is provided in the first member 15.

The radiation source unit 5 is mounted on a distal end of the second member 16 of the arm 4 by a mounting member 17. The mounting member 17 supports the radiation source unit 5 to be swingable. The mounting member 17 is mounted so as to be rotatable around a major axis of the second member 16.

In a case where the radiographic imaging apparatus 1 is used, for example, as illustrated in FIG. 2, an upper body of a subject H is raised on a patient table 30, and a radiation detector 31 for generating a radiation image in which radiation transmitted through the subject H is detected is inserted between a raised portion of the patient table 30 and the subject H. The operator moves the radiographic imaging apparatus 1 close to the patient table 30, unfolds the arm 4 that is in a folded state, and moves the radiation source unit 5 to perform alignment such that a predetermined part of the subject H is irradiated with the radiation at the set SID and the radiation is emitted perpendicularly to the radiation detector 31. The alignment of the radiation source unit 5 will be described later.

The radiation detector 31 is a cassette type detector configured to acquire the radiation image of the subject H by detecting the radiation. Further, the radiation detector 31 is a wireless detector, and transmits the radiation image acquired by the irradiation with the radiation to the computer 10 wirelessly.

In the present embodiment, the radiation detector 31 includes a motion sensor 32. The motion sensor 32 is a nine-axis motion sensor that detects three-axis acceleration, three-axis angular velocity, and three-axis tilt of the radiation detector 31. The acceleration, the angular velocity, and the tilt detected by the motion sensor 32 are output to the computer 10 as movement information. The processing using the movement information will be described later.

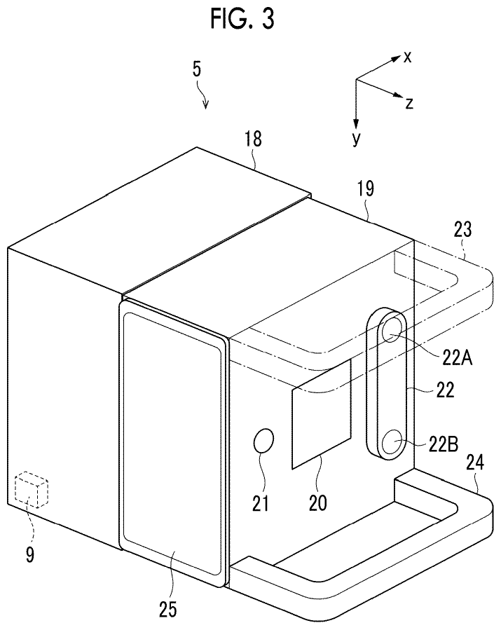

FIG. 3 is a diagram illustrating a detailed configuration of the radiation source unit. As illustrated in FIG. 3, the radiation source unit 5 includes a tube housing part 18 that accommodates a radiation tube such as an X-ray tube, and a collimator 19 that is mounted on the tube housing part 18 so as to be rotatable around an optical axis of the radiation. An emission window 20 for radiation, an optical camera 21, a stereo camera 22, and two handles 23 and 24 are mounted on a radiation emission surface of the collimator 19. A display 25 is mounted on a side surface of the collimator 19. In FIG. 3, the handle 23 is illustrated in phantom for illustrating a configuration of the collimator 19. The display 25 may be mounted on a side surface or a rear surface of the tube housing part 18 instead of the collimator 19. In addition, a motion sensor 9 is mounted on the radiation source unit 5.

The collimator 19 sets an irradiation field of the radiation by changing a size of the emission window 20. The irradiation field is set in response to the instruction from the operation panel 14. An irradiation field lamp that is a visible light source is mounted inside the emission window 20 of the collimator 19. By turning on the irradiation field lamp, the subject is irradiated with visible light, and an irradiation range of the visible light changes in accordance with the size of the emission window 20. As a result, the operator can check the radiation irradiation field on the subject H.

The optical camera 21 acquires an optical image G1 in a direction in which the radiation is emitted from the radiation source unit 5. The optical image G1 is a moving image at a predetermined frame rate in which an object on a side irradiated with the radiation from the radiation source unit 5 is represented by RGB pixels. The acquired optical image G1 is displayed on the display 25 as will be described later. The optical camera 21 is configured to acquire a color optical image G1, but may acquire a monochrome optical image G1.

The stereo camera 22 includes two cameras 22A and 22B, and acquires an imaging distance image G2 by measuring a distance based on the principle of triangulation. The imaging distance image G2 is also a moving image at a predetermined frame rate. In the imaging distance image G2, each pixel represents an imaging distance in a direction from the radiation source unit 5 toward the subject. A time-of-flight (TOF) camera that measures a distance by a time for light to return may be used instead of the stereo camera 22. The imaging distance image may be derived by using a light detection and ranging (LiDAR) sensor. The stereo camera 22, the TOF camera, and the LiDAR sensor are examples of a sensor that acquires distance information representing an imaging distance according to the present disclosure. The imaging distance image G2 is an example of distance information representing an imaging distance according to the present disclosure. The distance information is not limited to an image format, and may be a numerical value representing the imaging distance itself.

The handles 23 and 24 are used by the operator to grip and adjust a position and an angle of the radiation source unit 5. Here, in a case where an x-axis, a y-axis, and a z-axis are set as illustrated in FIG. 3, the collimator 19 is mounted on the tube housing part 18 so as to be rotatable around the z-axis. Therefore, the irradiation field of the radiation for the subject H can be rotated. In addition, as illustrated in FIG. 1, the radiation source unit 5 is mounted on the second member 16 so as to be rotatable around the major axis of the second member 16 and is mounted on the second member 16 so as to be swingable by the mounting member 17. Therefore, the angles around the x-axis and the y-axis illustrated in FIG. 3 can be adjusted.

The optical image G1 captured by the optical camera 21 is displayed on the display 25. The display content on the display 25 will be described later.

The motion sensor 9 is a nine-axis motion sensor that detects three-axis acceleration, three-axis angular velocity, and three-axis tilt of the radiation source unit 5. The acceleration, the angular velocity, and the tilt detected by the motion sensor 9 are output to the computer 10 as movement information. The motion sensor 9 is an example of a first angle sensor according to the present disclosure.

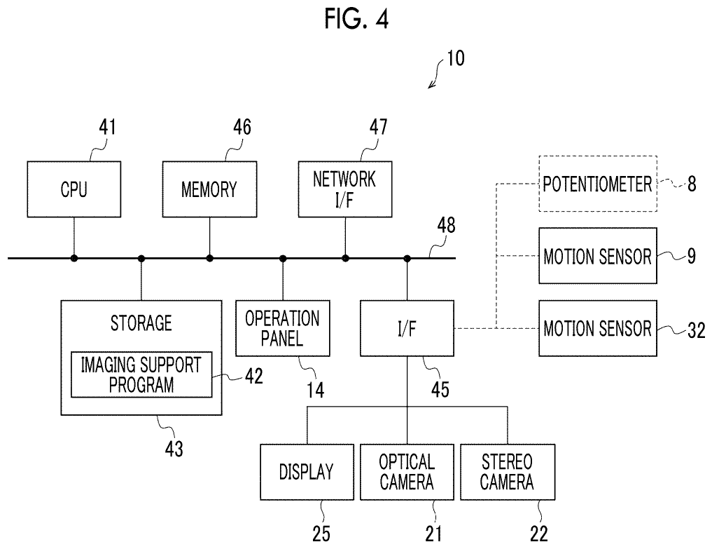

Hereinafter, the computer for executing processing of the imaging support apparatus according to the present embodiment will be described. FIG. 4 is a diagram illustrating a hardware configuration of the computer for executing the processing of the imaging support apparatus. As illustrated in FIG. 4, the computer 10 includes a central processing unit (CPU) 41, a non-volatile storage 43, and a memory 46 as a temporary storage area. In addition, the computer 10 includes the operation panel 14, a network interface (I/F) 47 that is connected to a network (not illustrated), and a wired and wireless I/F 45 for connecting the optical camera 21, the stereo camera 22, and the display 25 to the computer 10. The potentiometer 8 of the arm 4, the motion sensor 9 of the radiation source unit 5, and the motion sensor 32 of the radiation detector 31 are connected to the computer 10 by wireless communication via the I/F 45. The CPU 41, the storage 43, the operation panel 14, the I/F 45, the memory 46, and the network I/F 47 are connected to a bus 48. The CPU 41 is an example of a processor according to the present disclosure.

The computer 10 performs processing of displaying the radiation image acquired by the radiation detector 31 and transmitting the radiation image to an external apparatus or the like, but detailed description of these types of processing will be omitted here. The computer 10 includes the imaging support apparatus according to the present embodiment. Therefore, in the following description, the imaging support apparatus according to the present embodiment will also be denoted by reference numeral 10.

The storage 43 is implemented by a hard disk drive (HDD), a solid state drive (SSD), a flash memory, and the like. An imaging support program 42 is stored in the storage 43 as a storage medium. The CPU 41 reads out the imaging support program 42 from the storage 43, loads the readout imaging support program 42 into the memory 46, and executes the loaded imaging support program 42.

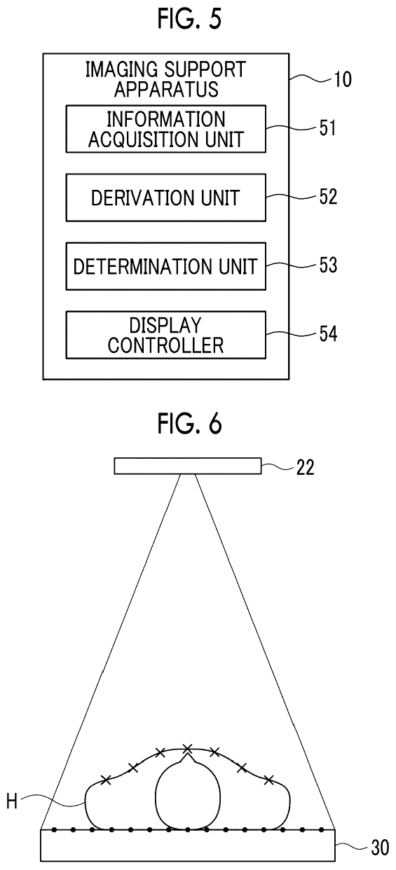

Hereinafter, a functional configuration of the imaging support apparatus according to the present embodiment will be described. FIG. 5 is a diagram illustrating the functional configuration of the imaging support apparatus according to the present embodiment. As illustrated in FIG. 5, the imaging support apparatus 10 comprises an information acquisition unit 51, a derivation unit 52, a determination unit 53, and a display controller 54. In a case where the CPU 41 executes the imaging support program 42, the CPU 41 functions as the information acquisition unit 51, the derivation unit 52, the determination unit 53, and the display controller 54.

The information acquisition unit 51 acquires the optical image G1 acquired by the optical camera 21, and the imaging distance image G2 acquired by the stereo camera 22. Further, the information acquisition unit 51 acquires angle information representing an angle between the first member 15 and the second member 16 output by the potentiometer 8. Furthermore, the information acquisition unit 51 also acquires the movement information output by the motion sensors 9 and 32.

The derivation unit 52 derives a relative angle between the radiation source unit 5 and a target plane. In the present embodiment, the target plane is a detection surface of the radiation detector 31. The derivation unit 52 derives the relative angle between the radiation source unit 5 and the target plane based on the movement information acquired from each of the motion sensor 9 of the radiation source unit 5 and the motion sensor 32 of the radiation detector 31.

Here, in the present embodiment, the radiographic imaging apparatus 1 is moved to a leg side of the subject H with respect to the patient table 30 as illustrated in FIG. 2. In such a situation, the derivation unit 52 acquires a rotation angle of the radiation source unit 5 around the x-axis and the y-axis and a rotation angle of the radiation detector 31 around the x-axis and the y-axis from the motion sensor 9 of the radiation source unit 5 and the motion sensor 32 of the radiation detector 31, respectively. Then, relative angles αx and αy of the radiation source unit 5 and the radiation detector 31 around the x-axis and the y-axis are derived. For example, in a case where the rotation angle of the radiation source unit 5 around the x-axis is 8.2° and the rotation angle of the radiation detector 31 around the x-axis is 10°, the relative angle αx=10−8.2=1.8° is derived by calculation.

Further, the derivation unit 52 detects a plane in the imaging distance image G2, and derives a distance from the radiation source unit 5 to the detected plane. FIG. 6 is a diagram illustrating plane detection. As illustrated in FIG. 6, for a distance within a certain angle of view from the stereo camera 22 near the subject H on the patient table 30, the surface of the patient table 30 is flat and has a certain area, so that the imaging distances in the plurality of pixels are within a predetermined range, and a pixel group (indicated by black circles in FIG. 6) in which the imaging distances are within the predetermined range has an area equal to or larger than a certain value. On the other hand, the surface of the subject H is curved, and thus the imaging distances in the plurality of pixels (indicated by ×marks in FIG. 6) representing the surface of the subject H exceed the predetermined range. In addition, the predetermined range can be, for example, ±2 cm.

Therefore, in a case where the imaging distances in the plurality of pixels are within the predetermined range and the pixel group in which the imaging distances are within the predetermined range has an area equal to or larger than a certain value in the imaging distance image G2, the derivation unit 52 determines that the pixel group constitutes the plane. Then, the derivation unit 52 derives the distance from the radiation source unit 5 based on the imaging distance image G2 only on the determined plane. There is variation in the imaging distance of each pixel in the plane determined in the imaging distance image G2, and thus a representative value such as an average value and a median value of the imaging distance is derived as the distance from the radiation source unit 5.

Further, the derivation unit 52 may detect a region of the radiation detector 31 included in the optical image G1, and derive the distance from the radiation source unit 5 only in the region of the radiation detector 31. In this case, the detection of the region of the radiation detector 31 may be performed by using a detection model constructed by machine learning using images of a plurality of radiation detectors 31 as training data.

In addition, the distance from the radiation source unit 5 to the plane is the SID in a case where the plane is the detection surface of the radiation detector 31. On the other hand, in a case where the radiation detector 31 is not installed behind the subject H, the distance from the radiation source unit 5 to the plane is the distance from the radiation source unit 5 to the surface of the patient table 30 on which the subject H is placed, but, for ease of description, the distance from the radiation source unit 5 to the plane is referred to as the SID regardless of the presence or absence of the radiation detector 31.

Further, the derivation unit 52 derives a body thickness of the subject H based on the SID and the distance from the radiation source unit 5 to the surface of the subject H based on the imaging distance image G2. The distance to the surface of the subject H may be a distance to a position of the subject H closest to the radiation source unit 5, or a representative value (for example, an average value or a center value) of the distances of a predetermined range including the closest position. In addition, the derivation unit 52 sets the imaging conditions in accordance with the derived body thickness. The imaging conditions include, for example, a tube voltage (keV) and an mAs value. In this case, the imaging conditions with a larger tube voltage and mAs value are set as the body thickness is larger. The derivation of the body thickness and the setting of the imaging conditions may be performed after a third operation process described later is completed.

In addition, the derivation unit 52 detects the target position of the subject H during the imaging from the optical image G1. The target position varies in accordance with the imaging menu. For example, in a case of chest imaging, a center position of a chest is the target position, and in a case of abdominal imaging, a center position of an abdomen is the target position. Therefore, the derivation unit 52 detects the target position of the subject H in the optical image G1 by using a learning model constructed by being trained through machine learning to detect the target position in accordance with the imaging menu.

Here, in a case where the subject H is imaged using the radiographic imaging apparatus 1, the operator performs a plurality of operations for aligning the radiation source unit 5 and the subject H. Specifically, first, the operator performs an operation of moving the radiographic imaging apparatus 1 close to the patient table 30 of the subject H and unfolding the arm 4 that is in a folded state. This process is defined as a first operation process.

In a case where the first operation process is completed, the operator performs an operation of roughly aligning the position such that the radiation source unit 5 faces the subject H on the patient table 30 and the SID matches the target distance corresponding to the imaging menu. This process is defined as a second operation process.

In a case where the second operation process is completed, the operator performs an operation of inserting the radiation detector 31 between the subject H and the patient table 30, and finely adjusting the relative angle between the radiation source unit 5 and the radiation detector 31, the SID, and the imaging position. This process is defined as the third operation process. In this way, the precision of the alignment is different between the second operation process and the third operation process. In addition, in the following description, the relative angle between the radiation source unit 5 and the radiation detector 31 may be simply referred to as the relative angle.

The operation of finely adjusting the relative angle is an operation of minimizing an absolute value of the relative angle. The operation of adjusting the SID is an operation of setting the SID to the target distance. The operation of finely adjusting the imaging position is an operation of moving the center of the irradiation field of the radiation to the target position for the subject imaging.

In a case where the third operation process is completed, the operator performs an operation of setting the imaging conditions. This process is defined as a fourth operation process.

In a case where the fourth operation process is completed, the operator operates the operation panel 14 to perform the radiographic imaging of the subject H.

The determination unit 53 determines the completion of the plurality of operation processes for alignment between the radiographic imaging apparatus 1 and the subject H, that is, the first to fourth operation processes described above. First, the determination unit 53 determines the completion of the first operation process based on the angle information between the first member 15 and the second member 16 acquired by the information acquisition unit 51 from the potentiometer 8. Here, in a case where the arm 4 is unfolded, the angle between the first member 15 and the second member 16 of the arm 4 increases, so that the angle information output by the potentiometer 8 increases. In a case where the angle information exceeds a predetermined threshold value (for example, 90°), the determination unit 53 determines that the arm 4 is unfolded, and determines that the first operation process is completed based on this determination.

In a case where the first operation process is completed, the operator performs rough alignment of the distance between the radiation source unit 5 and the patient table 30, as the second operation process. In a case where the rough alignment is performed, the imaging distance image G2 acquired by the stereo camera 22 includes the plane of the patient table 30. Therefore, the determination unit 53 detects the plane from the imaging distance image G2 during the second operation process. In a case where the derivation unit 52 detects the plane in the imaging distance image G2, the determination unit 53 determines that the second operation process is completed.

In a case where the second operation process is completed, the operator performs the operation of finely adjusting the relative angle between the radiation source unit 5 and the radiation detector 31, the SID, and the imaging position, as the third operation process. Regarding the relative angle, the operator adjusts the position of the radiation source unit 5 such that the absolute value of the relative angle becomes as small as possible. The determination unit 53 determines whether or not the relative angle has fallen within a predetermined angle range (for example, less than ±2°).

Regarding the SID, the operator adjusts the position of the radiation source unit 5 such that the SID becomes the target distance. The determination unit 53 determines whether or not the SID has fallen within a predetermined distance range (for example, less than ±1 cm) with respect to the target distance.

Regarding the imaging position, the operator adjusts the position of the radiation source unit 5 such that the center of the irradiation field is moved to the target position of the subject H. The determination unit 53 determines whether or not the distance between the center of the irradiation field of the radiation and the target position that is a target for the imaging of the subject in the optical image G1 has fallen within a predetermined distance range (for example, less than ±3 cm). Then, in a case where all of the three determinations are affirmative, the determination unit 53 determines that the third operation process is completed.

In a case where the third operation process is completed, the operator sets the imaging conditions in a case where the radiographic imaging of the subject H is performed, as the fourth operation process. In a case where the determination unit 53 determines that the third operation process is completed, the irradiation field lamp of the collimator 19 is turned on. As a result, the light irradiation field is displayed on the subject H. On the other hand, in a case where the relative angle exceeds a predetermined angle range after the light irradiation field is emitted, in a case where the SID exceeds a predetermined distance range, or in a case where the distance between the center of the irradiation field of the radiation and the target position for imaging the subject exceeds a predetermined distance range, the determination unit 53 turns off the irradiation field lamp. As a result, the operator can recognize that any of the relative angle, the SID, or the imaging position departs from the aligned state. In a case where the relative angle, the SID, and the imaging position are aligned again after the recognition, the determination unit 53 turns on the irradiation field lamp. As a result, the light irradiation field is displayed on the subject H again, and thus the operator can recognize that the alignment is performed again.

In the fourth operation process, the operator sets the imaging conditions. In this case, the operator adjusts the irradiation field by the collimator 19 as required. The irradiation field is adjusted by adjusting a range of the emission window 20 in accordance with the instruction from the operation panel 14.

After the imaging conditions and the irradiation field are set, the operator operates the operation panel 14 to issue an instruction to emit the radiation. The determination unit 53 determines whether or not the operator has issued the instruction to emit the radiation on the operation panel 14, and, in a case where this determination is affirmative, the determination unit 53 determines that the fourth operation process is completed.

In a case where the determination unit 53 determines the completion of each operation process, the display controller 54 displays an indicator for the alignment on the display 25 in the operation process next to the completed operation process. Hereinafter, the indicator displayed after the completion of each operation process will be described. During the first operation process, the display 25 is turned off, and nothing is displayed.

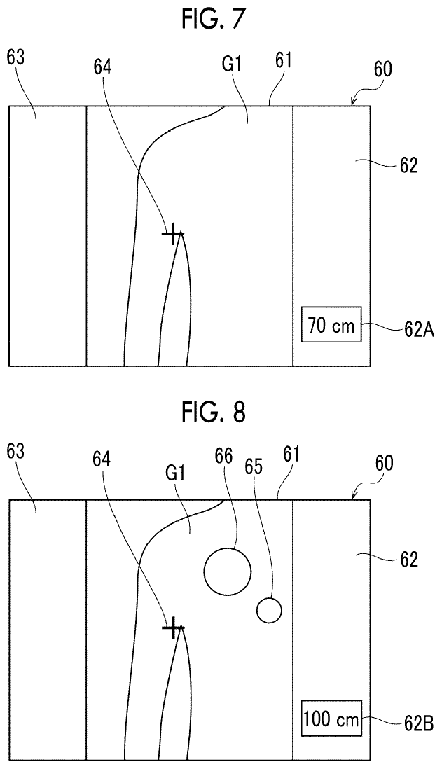

FIG. 7 is a diagram illustrating a display screen of the display after the first operation process is completed. As illustrated in FIG. 7, a first display region 61 for displaying the optical image G1 acquired by the optical camera 21, a second display region 62 for displaying the indicator for alignment, and a third display region 63 for displaying the indicator for the alignment are displayed on a display screen 60.

In a case where the angle between the first member 15 and the second member 16 exceeds the predetermined angle and the determination unit 53 determines that the first operation process is completed, the optical image G1 is displayed in the first display region 61. A center indicator 64 indicating the center of the irradiation field is displayed near the center of the optical image G1. In the second display region 62, distance information 62A indicating the distance from the radiation source unit 5 to the center of the irradiation field of the radiation in the imaging range of the optical image G1 is displayed as a numerical value. In FIG. 7, a numerical value “70 cm” is displayed as the distance information 62A. The distance information 62A may display icons indicating the distances stepwise instead of the numerical value. Here, the imaging ranges of the optical image G1 and the imaging distance image G2 substantially match. Therefore, the distance information uses the imaging distance in the pixel near the center of the imaging distance image G2. The numerical value of the distance information 62A is changed in accordance with the distance from the radiation source unit 5 to the center of the irradiation field of the radiation in the imaging range of the optical image G1.

During the second operation process after the first operation process, the operator performs the operation of roughly aligning the position such that the radiation source unit 5 faces the subject H on the patient table 30 and the distance between the radiation source unit 5 and the surface of the patient table 30 matches the SID corresponding to the imaging menu while viewing the distance information 62A. For example, in a case where the SID is 100 cm, the alignment operation is performed such that the distance information 62A is approximately 100 cm.

In a case where the plane is detected in the imaging distance image G2 during the second operation process, the determination unit 53 determines that the second operation process is completed. In a case where the plane is detected, the display controller 54 may display the distance from the radiation source unit 5 to the plane, that is, the SID as the distance information 62A.

In addition, the installation of the radiation detector 31 between the subject H and the patient table 30 may be performed before the first operation process, before the second operation process after the first operation process, or before the third operation process after the second operation process.

In a case where the plane is detected in the imaging distance image G2 and the determination unit 53 determines that the second operation process is completed, the display controller 54 displays a target indicator 65 indicating the target position of the subject H during the imaging detected by the derivation unit 52 in the first display region 61 as illustrated in FIG. 8. Further, the display controller 54 displays an angle indicator 66 indicating the relative angle in the first display region 61. An SID 62B is displayed in the second display region 62. The SID 62B may display icons indicating the SID stepwise instead of the numerical value. The position of the angle indicator 66 on the optical image G1 is moved in accordance with the change in the relative angle. A state where the angle indicator 66 substantially matches the target indicator 65 is a state where the relative angle between the radiation source unit 5 and the radiation detector 31 has fallen within the predetermined angle range.

In the third operation process after the second operation process, the operator finely adjusts the position of the radiation source unit 5 such that the SID 62B becomes the target distance in accordance with the imaging menu while viewing the SID 62B. In addition, the operator finely adjusts the tilt of the radiation source unit 5 such that the angle indicator 66 matches the target indicator 65 while viewing the target indicator 65 and the angle indicator 66. Further, the operator finely adjusts the position of the radiation source unit 5 such that the target indicator 65 matches the center indicator 64 indicating the imaging center.

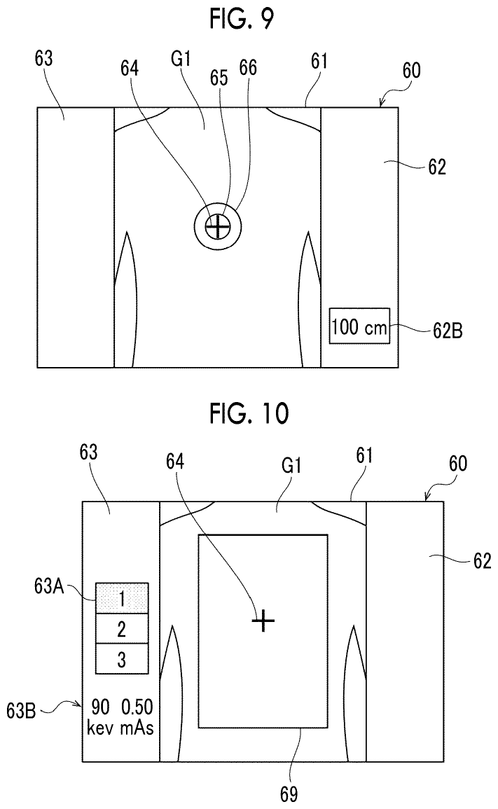

In a case where the relative angle has fallen within the predetermined angle range (for example, less than ±2°), the SID 62B has fallen within the predetermined distance range (for example, less than ±1 cm) with respect to the target distance, and the distance between the center of the irradiation field of the radiation and the target position that is the target for the imaging of the subject has fallen within the predetermined distance range (for example, less than ±3 cm), the positions of the center indicator 64, the target indicator 65, and the angle indicator 66 substantially match on the display screen 60 as illustrated in FIG. 9. In this state, the alignment between the radiation source unit 5 and the radiation detector 31 is completed.

In a case where the determination unit 53 determines that the third operation process is completed in such a state, the display controller 54 displays an estimated body thickness 63A and imaging conditions 63B in the third display region 63 as illustrated in FIG. 10. The SID 62B, the target indicator 65, and the angle indicator 66 displayed during the third operation process are hidden. The center indicator 64 may be continuously displayed, or may be hidden.

The optical image G1 displayed on the display screen 60 illustrated in FIG. 10 includes a light irradiation field 69. In a case where the determination unit 53 determines that the third operation process is completed as described above, the subject H is irradiated with the light irradiation field 69. Therefore, the optical image G1 includes the light irradiation field 69.

The body thickness 63A is assigned with numbers 1 to 3, which represent that the body thickness of the subject H becomes thinner in the order of 1 to 3. Here, the body thickness of the subject H is classified into three stages, and a body thickness 1 is 40 cm or more, a body thickness 2 is 30 cm or more and less than 40 cm, and a body thickness 3 is less than 30 cm. In the body thickness 63A, any one of 1, 2, or 3 is highlighted in accordance with the value of the body thickness derived by the derivation unit 52. In FIG. 10, the “1” is highlighted by adding diagonal lines to the “1” region. Icons indicating the change in the thickness stepwise may be used instead of representing the thicknesses in the body thickness 63A with the numerical values stepwise.

The imaging conditions 63B display the imaging conditions set by the derivation unit 52 in accordance with the body thickness. In FIG. 10, the tube voltage is displayed as 90 keV, and the mAs value is displayed as 0.50 mAs.

During the fourth operation process after the third operation process, the operator performs an operation of resetting the imaging conditions as required by using the operation panel 14. Further, the light irradiation field 69 is adjusted as required to adjust the irradiation field of the radiation. Then, in a case where the setting of the imaging conditions is completed, an instruction to perform the imaging is issued from the operation panel 14. As a result, the subject H is irradiated with the radiation from the radiation source unit 5, and the radiation image of the subject H is acquired by the radiation detector 31.

After the imaging is performed, the determination unit 53 may turn off the power of the radiographic imaging apparatus 1 after a predetermined time has elapsed.

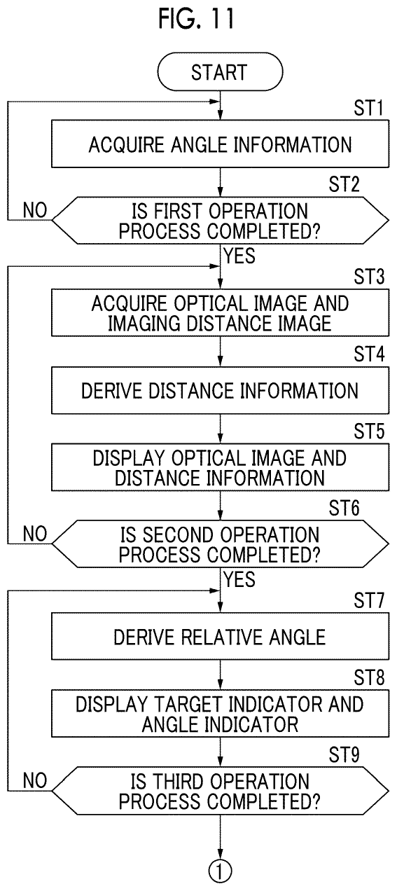

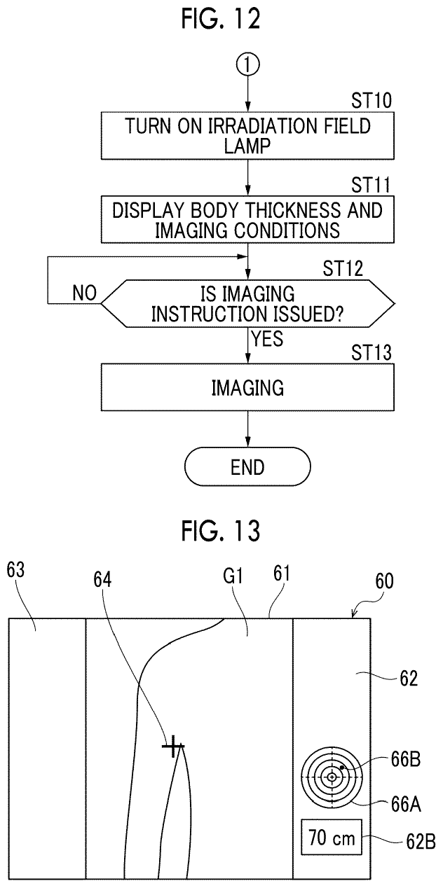

Hereinafter, processing performed in the present embodiment will be described. FIGS. 11 and 12 are flowcharts illustrating the processing performed in the present embodiment. First, the information acquisition unit 51 acquires the angle information from the potentiometer 8 (step ST1), and the determination unit 53 starts monitoring whether or not the arm 4 is unfolded and the first operation process is completed (step ST2).

In a case where the determination in step ST2 is affirmative, the information acquisition unit 51 acquires the optical image G1 and the imaging distance image G2 (step ST3), and the derivation unit 52 derives the distance information 62A indicating the distance from the radiation source unit 5 to the center of the irradiation field of the radiation in the imaging range of the optical image G1 (step ST4). Furthermore, the display controller 54 displays the optical image G1 and the distance information 62A on the display 25 (step ST5). The determination unit 53 determines whether or not the second operation process is completed by detecting the plane in the imaging distance image G2 (step ST6). In a case where the determination in step ST6 is negative, the processing returns to step ST3, and the processing of steps ST3 to ST6 is repeated.

In a case where the determination in step ST6 is affirmative, the derivation unit 52 derives the relative angle (step ST7), and the display controller 54 displays the target indicator 65 and the angle indicator 66 (step ST8). The determination unit 53 determines whether or not the third operation process is completed by determining whether or not the relative angle has fallen within the predetermined angle range, the SID has fallen within the predetermined distance range with respect to the target distance, and the distance between the target position that is the target of the imaging of the subject and the center of the irradiation field of the radiation has fallen within the predetermined distance range (step ST9). In a case where the determination in step ST9 is negative, the processing returns to step ST7, and the processing of steps ST7 to ST9 is repeated.

In a case where the determination in step ST9 is affirmative, the determination unit 53 turns on the irradiation field lamp (step ST10), and displays the body thickness 63A and the imaging conditions 63B in the third display region 63 instead of displaying the distance information 62A, the target indicator 65, and the angle indicator 66 (step ST11). The operator sets the imaging conditions 63B and the irradiation field as required. Then, the determination unit 53 starts monitoring whether or not the instruction to perform the imaging is issued (step ST12), and in a case where the determination in step ST12 is affirmative, the radiation is emitted from the radiation source unit 5 to perform the imaging of the subject H (step ST13), and the processing ends.

As described above, in the present embodiment, the indicator for the alignment is displayed in accordance with the completed operation process. Therefore, it is possible to easily check the information required in each operation process.

In particular, by displaying the indicator for the alignment corresponding to the completed operation process instead of the indicator displayed on the display during the completed operation process, only the indicator for the operation process to be performed next is displayed. Therefore, it is possible to more easily check the information required in each operation process.

In the above-described embodiment, the indicator displayed on the display screen 60 may be changed in accordance with the imaging menu. For example, as illustrated in FIG. 2, in a case where the upper body of the subject H is raised to perform the imaging of the chest of the subject H, it can be known which position of subject H should be the target position by looking at subject H. Therefore, after the second operation process is completed, as illustrated in FIG. 13, the target indicator 65 may not be displayed on the optical image G1, and the angle indicator 66A may be displayed in the second display region 62 in addition to the SID 62B. The angle indicator 66A includes a black circle 66B, and in a case where the relative angle is changed, a position of the black circle 66B is changed in the angle indicator 66A. The operator can perform the alignment of the relative angle by adjusting the angle of the radiation source unit 5 such that the black circle 66B is moved to the center of the angle indicator 66A.

Meanwhile, in a case where the subject H is imaged in a state where the subject H is lying on the patient table, it is difficult to know the center of the target position. Therefore, it is preferable to display the target indicator 65 as illustrated in FIG. 8.

In the above-described embodiment, the completion of each operation process is determined in accordance with the angle between the first member 15 and the second member 16, the imaging distance, the relative angle, and the like, but the present disclosure is not limited to this. Each time each operation process is completed, the operator may issue an instruction from the operation panel 14 that the operation process is completed, and the determination unit 53 may determine the completion of each operation process based on the input instruction.

In the above-described embodiment, the irradiation field lamp is turned on to irradiate the subject H with the light irradiation field in a case where the third operation process is completed, but the present disclosure is not limited to this. The subject H may be irradiated with the light irradiation field only in a case where the relative angle during the third operation process satisfies the condition, only in a case where the imaging distance satisfies the condition, only in a case where the imaging center matches the target position, or only in a case where any two of the three conditions are satisfied.

In the above-described embodiment, in a case where the indicator for the alignment corresponding to the completed operation process is displayed instead of the indicator displayed on the display during the completed operation process, only some of the indicators of the completed operation process may be hidden. For example, after the third operation process is completed, only some of the SID 62B, the target indicator 65, or the angle indicator 66 displayed in the third operation process may be hidden instead of hiding all of the SID 62B, the target indicator 65, and the angle indicator 66 displayed during the third operation process.

In the present embodiment, each processing is executed by any computer. Also, any computer may execute these processes by a processor as hardware, a program as software, or a combination thereof. In such a case, the processor is configured to execute various types of processing in the present embodiment in cooperation with the program and can function as each unit or each means in the present embodiment. Furthermore, the execution order of the processing by the processor is not limited to the above-described order, and may be changed as appropriate. Any computer may be a general-purpose computer, a computer for specific use, a workstation, or another system that can execute each processing.

The processor may be configured by one or more hardware components, and the type of hardware is not limited. For example, the processor may be configured by hardware, such as a central processing unit (CPU), a micro processing unit (MPU), a programmable logic device, such as a field programmable gate array (FPGA), a dedicated circuit that is used to execute specific processing, such as an application-specific integrated circuit (ASIC), a graphics processing unit (GPU), or a neural processing unit (NPU). Furthermore, the type of hardware may be a combination of different types of hardware components. In a case where the plurality of hardware components are configured to execute one or a plurality of types of processing of a certain processor, the plurality of hardware components may be present in devices physically separated from each other or may be present in the same device. Additionally, in any embodiment, the order of each processing by the processor is not limited to the order described above and may be changed as appropriate. In addition, the hardware is configured by an electrical circuit (circuitry) in which circuit elements, such as semiconductor elements, are combined.

Further, the program may be software such as firmware or microcode. Additionally, the program may be, for example, a program module group, and each function thereof may be executed by the processor configured to execute the corresponding function. The program may be a program code or a plurality of code segments stored in one or more non-transitory computer-readable media (for example, storage media or other storages). The program may be distributed and stored across a plurality of non-transitory computer-readable media existing in devices physically separated from each other. The program code or the code segment may represent a procedure, function, subprogram, routine, subroutine, module, software package, class, or any combination of instructions, data structures, or program statements. The program code or the code segment may be connected to another code segment or a hardware circuit by the transmission and reception of information, data, arguments, parameters, or contents in the memory.

In addition, in the above-described embodiment, the imaging support program 42 is stored (installed) in the storage 43 in advance, but the present disclosure is not limited to this. The imaging support program 42 may be provided in a form recorded on a recording medium, such as a compact disc read-only memory (CD-ROM), a digital versatile disc read-only memory (DVD-ROM), and a universal serial bus (USB) memory. In addition, the imaging support program 42 may be downloaded from an external apparatus through the network.

The disclosed technology is applicable to any program product. The program product includes all forms of products for providing the program. For example, the program product includes a program provided through a network such as the Internet, a non-transitory computer-readable recording medium such as a CD-ROM, a DVD, and a USB memory in which the program is stored and the like.

Hereinafter, supplementary notes of the present disclosure are set forth.

### Supplementary Note 1

An imaging support apparatus for a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, the imaging support apparatus comprising: a display; and a processor, in which the processor is configured to: determine completion of each of a plurality of operation processes for alignment of the radiographic imaging apparatus; and display an indicator for the alignment corresponding to the completed operation process on the display.

### Supplementary Note 2

The imaging support apparatus according to supplementary note 1, in which the processor is configured to display the indicator for the alignment corresponding to the completed operation process instead of an indicator displayed on the display during the completed operation process.

### Supplementary Note 3

The imaging support apparatus according to supplementary note 1 or 2, in which the processor is configured to determine the completion of the operation process in accordance with at least one of whether an angle of the arm has reached a predetermined angle, whether a distance from the radiation source to a surface of a patient table on which the subject is placed or to a detection surface of a radiation detector installed behind the subject has reached a predetermined distance, whether a relative angle between the radiation source and the radiation detector has reached a predetermined angle, whether a target position of the subject and an irradiation center of the radiation have fallen within a predetermined range, or whether an operation by an operator has been received.

### Supplementary Note 4

The imaging support apparatus according to any one of supplementary notes 1 to 3, in which the indicator includes at least one of a distance from the radiation source to a surface of a patient table on which the subject is placed or to a detection surface of a radiation detector installed behind the subject, a relative angle between the radiation source and the radiation detector, a target position of the subject, an irradiation center of the radiation, imaging conditions, or a body thickness of the subject.

### Supplementary Note 5

The imaging support apparatus according to any one of supplementary notes 1 to 4, in which the processor is configured to change the indicator displayed on the display in accordance with an imaging menu for imaging the subject.

### Supplementary Note 6

The imaging support apparatus according to any one of supplementary notes 1 to 5, in which the processor is configured to change the indicator in accordance with precision of the alignment in an operation process to be performed next to the completed operation process.

### Supplementary Note 7

The imaging support apparatus according to any one of supplementary notes 1 to 6, in which the processor is configured to, in a case where the alignment is completed in at least one of the plurality of operation processes, instruct the radiographic imaging apparatus to perform an operation indicating that the alignment is completed.

### Supplementary Note 8

The imaging support apparatus according to supplementary note 7, in which the processor is configured to determine that the alignment is completed in at least one of the plurality of operation processes in accordance with at least one of whether a distance from the radiation source to a surface of a patient table on which the subject is placed or to a detection surface of a radiation detector installed behind the subject has fallen within a predetermined distance range, whether a relative angle between the radiation source and the radiation detector has fallen within a predetermined angle range, or whether a distance between an irradiation center of the radiation and a target position of the subject has fallen within a predetermined distance range.

### Supplementary Note 9

The imaging support apparatus according to supplementary note 7 or 8, in which the processor is configured to instruct the radiographic imaging apparatus to perform an operation of irradiating the subject with a light irradiation field as the operation indicating that the alignment is completed.

### Supplementary Note 10

The imaging support apparatus according to supplementary note 9, in which the processor is configured to, in a case where the alignment departs from a completed state, instruct the radiographic imaging apparatus to perform an operation of turning off the light irradiation field.

### Supplementary Note 11

The imaging support apparatus according to any one of supplementary notes 1 to 10, in which the display is mounted on a radiation source unit including the radiation source.

### Supplementary Note 12

An imaging support method for a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, the imaging support method being executed by a computer, the imaging support method comprising: determining completion of each of a plurality of operation processes for alignment of the radiographic imaging apparatus; and displaying an indicator for the alignment corresponding to the completed operation process on a display.

### Supplementary Note 13

An imaging support program for a radiographic imaging apparatus including a radiation source that emits radiation, a body that is movable, an arm that is foldable and that connects the body to the radiation source, a sensor that acquires distance information representing an imaging distance in a direction from the radiation source toward a subject, and an optical camera that is mounted on the radiation source and that captures an optical image in the direction from the radiation source toward the subject, the imaging support program causing a computer to execute: a procedure of determining completion of each of a plurality of operation processes for alignment of the radiographic imaging apparatus; and a procedure of displaying an indicator for the alignment corresponding to the completed operation process on a display.

### Supplementary Note 14

A radiographic imaging apparatus comprising: a radiation source that emits radiation; a body that is movable; an arm that is foldable and that connects the body to the radiation source; a sensor that acquires distance information representing an imaging distance in a direction from the radiation source toward a subject; an optical camera that is mounted on the radiation source and that captures an optical image in the direction from the radiation source toward the subject; and the imaging support apparatus according to any one of supplementary notes 1 to 11.

What is claimed is:

1. An imaging support apparatus for a radiographic imaging apparatus including
a radiation source that emits radiation,
a body that is movable,
an arm that is foldable and that connects the body to the radiation source,
a sensor that acquires distance information representing an imaging distance in a direction from the radiation source toward a subject, and
an optical camera that is mounted on the radiation source and that captures an optical image in the direction from the radiation source toward the subject, the imaging support apparatus comprising:
a display; and
a processor,
wherein the processor is configured to:
determine completion of each of a plurality of operation processes for alignment of the radiographic imaging apparatus; and
display an indicator for the alignment corresponding to the completed operation process on the display.

2. The imaging support apparatus according to claim 1,
wherein the processor is configured to display the indicator for the alignment corresponding to the completed operation process instead of an indicator displayed on the display during the completed operation process.

3. The imaging support apparatus according to claim 1,
wherein the processor is configured to determine the completion of the operation process in accordance with at least one of whether an angle of the arm has reached a predetermined angle, whether a distance from the radiation source to a surface of a patient table on which the subject is placed or to a detection surface of a radiation detector installed behind the subject has reached a predetermined distance, whether a relative angle between the radiation source and the radiation detector has reached a predetermined angle, whether a target position of the subject and an irradiation center of the radiation have fallen within a predetermined range, or whether an operation by an operator has been received.

4. The imaging support apparatus according to claim 1,
wherein the indicator includes at least one of a distance from the radiation source to a surface of a patient table on which the subject is placed or to a detection surface of a radiation detector installed behind the subject, a relative angle between the radiation source and the radiation detector, a target position of the subject, an irradiation center of the radiation, imaging conditions, or a body thickness of the subject.

5. The imaging support apparatus according to claim 1,
wherein the processor is configured to change the indicator displayed on the display in accordance with an imaging menu for imaging the subject.

6. The imaging support apparatus according to claim 1,
wherein the processor is configured to change the indicator in accordance with precision of the alignment in an operation process to be performed next to the completed operation process.

7. The imaging support apparatus according to claim 1,
wherein the processor is configured to, in a case where the alignment is completed in at least one of the plurality of operation processes, instruct the radiographic imaging apparatus to perform an operation indicating that the alignment is completed.

8. The imaging support apparatus according to claim 7,
wherein the processor is configured to determine that the alignment is completed in at least one of the plurality of operation processes in accordance with at least one of whether a distance from the radiation source to a surface of a patient table on which the subject is placed or to a detection surface of a radiation detector installed behind the subject has fallen within a predetermined distance range, whether a relative angle between the radiation source and the radiation detector has fallen within a predetermined angle range, or whether a distance between an irradiation center of the radiation and a target position of the subject has fallen within a predetermined distance range.

9. The imaging support apparatus according to claim 7,
wherein the processor is configured to instruct the radiographic imaging apparatus to perform an operation of irradiating the subject with a light irradiation field as the operation indicating that the alignment is completed.

10. The imaging support apparatus according to claim 9,
wherein the processor is configured to, in a case where the alignment departs from a completed state, instruct the radiographic imaging apparatus to perform an operation of turning off the light irradiation field.

11. The imaging support apparatus according to claim 1,
wherein the display is mounted on a radiation source unit including the radiation source.

12. An imaging support method for a radiographic imaging apparatus including
a radiation source that emits radiation,
a body that is movable,
an arm that is foldable and that connects the body to the radiation source,
a sensor that acquires distance information representing an imaging distance in a direction from the radiation source toward a subject, and
an optical camera that is mounted on the radiation source and that captures an optical image in the direction from the radiation source toward the subject, the imaging support method being executed by a computer, the imaging support method comprising:
determining completion of each of a plurality of operation processes for alignment of the radiographic imaging apparatus; and
displaying an indicator for the alignment corresponding to the completed operation process on a display.

13. A non-transitory computer-readable storage medium that stores an imaging support program for a radiographic imaging apparatus including
a radiation source that emits radiation,
a body that is movable,
an arm that is foldable and that connects the body to the radiation source,
a sensor that acquires distance information representing an imaging distance in a direction from the radiation source toward a subject, and
an optical camera that is mounted on the radiation source and that captures an optical image in the direction from the radiation source toward the subject, the imaging support program causing a computer to execute:
a procedure of determining completion of each of a plurality of operation processes for alignment of the radiographic imaging apparatus; and
a procedure of displaying an indicator for the alignment corresponding to the completed operation process on a display.

14. A radiographic imaging apparatus comprising:
a radiation source that emits radiation;
a body that is movable;
an arm that is foldable and that connects the body to the radiation source;
a sensor that acquires distance information representing an imaging distance in a direction from the radiation source toward a subject;
an optical camera that is mounted on the radiation source and that captures an optical image in the direction from the radiation source toward the subject; and
the imaging support apparatus according to claim 1.
